(19) United States
(12) Patent Application Publication
(10) Pub. No.: US 2005/0065720 A1
(43) Pub. Date: Mar. 24, 2005

(54) System and method for real-time tracking, monitoring, and locating subjects

(76) Inventors: Yolanda Lewis, San Jose, CA (US); Vintory Levon-Blake Moore, San Jose, CA (US); Martez Cratch, San Jose, CA (US); Aaron McKinley Lewis, San Jose, CA (US)

Correspondence Address: Yolanda Lewis;Suite 200, 31 N. 2nd Street, San Jose, CA, 95113, US

(21) Appl. No.: 10/664,533

(22) Filed: Sep. 22, 2003

(51) Int. Cl. G01C 21/26

(52) U.S. Cl. 701/207; 342/450; 701/213

(57) ABSTRACT

A system and method for real-time tracking and monitoring a single or multiple transmitter devices. The receiving unit measures distance, direction, altitude (tracking on the Y axis) specific location as well as whether the transmitter is stationary or mobile. The ability to track altitude or coordinates on the Y-axis is integrated with the ability to provide verbal direction and information in the way of locating the subject. Utilization of a Graphical User Interface for displaying information on the subject being tracked is an integral part of this method and system. Unique encrypted PINS for secure monitoring are utilized for sending signals continuously utilizing pulse technology in unidirectional signals between the transmitter and receiver. The integrated memory component enables tracking the last coordinates sent out by the transmitting unit.

### SPECIFICATIONS

A system and method for real-time tracking and monitoring a single or multiple transmitter devices. The receiving unit measures distance, direction, altitude (tracking on the Y axis) specific location as well as whether the transmitter is stationary or mobile.

The method requires the use of at least one transmitter and one base station or receiver. The transmitter sends a continuous signal that contains a set of independent variables that express the coordinates of the transmitting device in relation to the receiver. The receiving unit is equipped with an alarm, which provides audible (including voice instructions), visible, and sensory notification when the transmitter has exceeded the predetermined distance from the receiver. The signal is not bidirectional sent only from the transmitter to the receiver.

The transmitting device is encrypted with a PIN so that one receiving unit for security can only learn the signal.

### FIELD OF THE INVENTION

This invention provides a method for tracking and monitoring the distance, direction, altitude, and specific location of a single or multiple transmitter(s) units utilizing a receiving unit. The base or receiving device utilizes a GUI as well as sensory and audio alarms, including voice commands providing information on each specific transmitter being tracked.

### BACKGROUND OF THE INVENTION

The use of systems and methods to monitor movements and locations utilizing a base receiving unit and transmitting unit to track pets, property, and individuals is currently available. Recently, an increase in awareness of child abductions, missing elderly and pets has increased the need for a practical solution. The critical point in recovery is immediate notification that a person or object is missing and acting within the first few minuets.

Currently, Global Positioning Satellite (GPS) based tracking and monitoring devices are used. The commonly used systems or methods utilize technology that requires Internet access as well as monthly reoccurring service fees. This technology is not real-time and has a delayed response, as the signal requires transmission to a satellite. GPS requires line of sight to the sky, and will not work in most buildings, as well, coverage is limited to particular regions.

The present invention's technology provides capability of real-time accurate monitoring of distance, direction, altitude, and specific location of a single or multiple transmitter units.

### INVENTION SUMMARY

The present inventions technology provides a system and method for real-time tracking and monitoring utilizing a GUI as well as spoken instruction, audio and sensory alarms to track the following; distance, direction, altitude, and specific location of a single or multiple transmitters utilizing a base station and transmitting device(s). This system and method monitors people, pets, or personal property.

The system includes, at least two components, a transmitter and a receiver. The receiver monitors the transmitter unit. The base or receiving unit utilizes low frequency pulsating technology broadcast by the transmitting unit to track and receive information about the location of the transmitting unit. The receiving unit provides information about the location of the transmitter unit in relation to the location of the receiving unit.

Information is filtered and analyzed by the receiving unit and is displayed in GUI format, utilizing audible including spoken instruction, as well as sensory alarms.

This invention will address the problems with children being left unattended in vehicles as a result of caregivers forgetting them, and provide immediate information on the location of children who may be lost or who have disappeared.

### DRAWINGS

FIG. 3 Illustrates the Main GUI of the Receiving Device

FIG. 4 Illustrates the GUI for Adding Profiles

FIG. 5 Illustrates the GUI for Deleting Profiles

FIG. 6 Illustrates the Programming GUI for Radius, Audio, Sensory, Time I Date and distance

### DESCRIPTION OF THE DRAWINGS

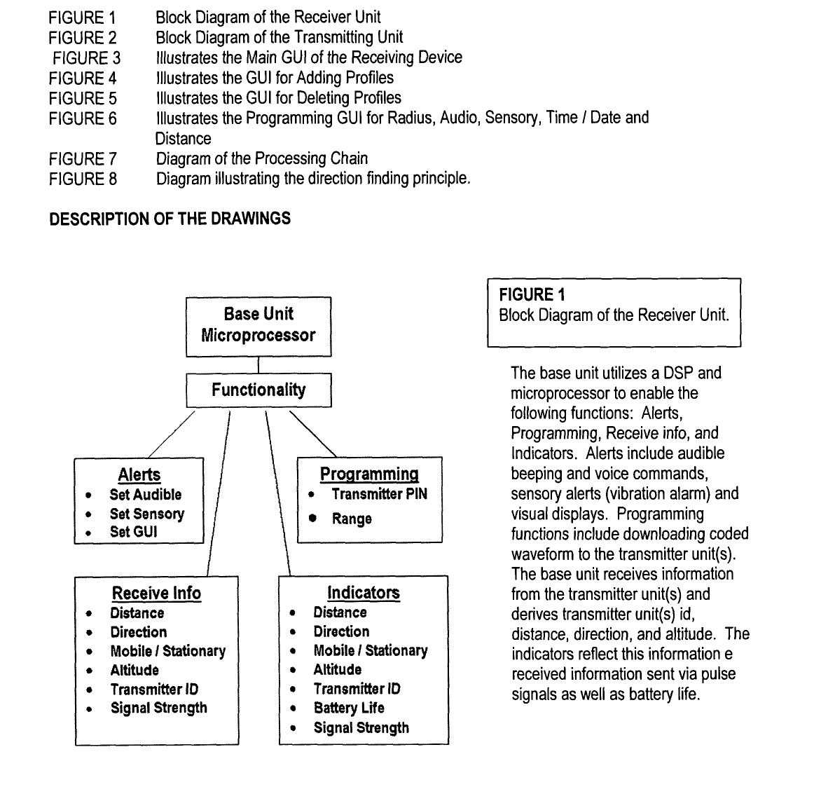

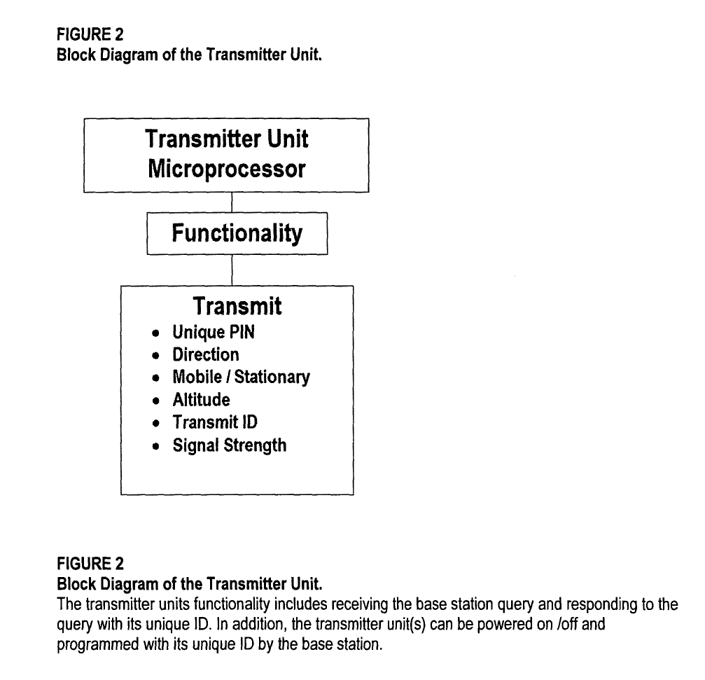

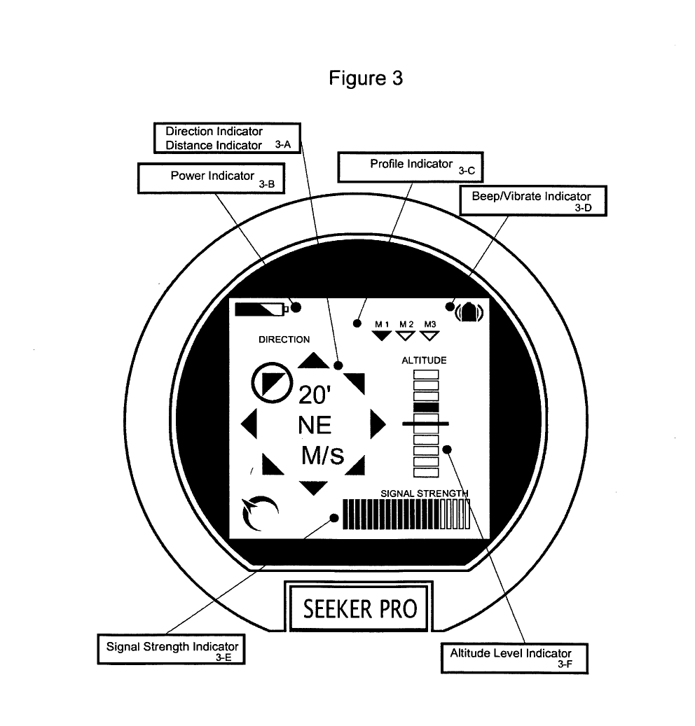

FIG. 3

Direction And Distance Indicator

The direction and distance indicator is used to point in the exact direction of the subject that has a transmitting device attached to it. The next function of this indicator is to display the distance of the transmitter in relation to that of the said receiving device. The third critical function this indicator displays is, weather the subject wearing the transmitter is stationary or mobile. The Direction on the indicator is displayed by placing a ring around the arrow that shows the position of the subject in relation to the position of the individual tracking the subject in real time. The distance of the subject is displayed in feet. The distance between the transmitter and the receiving device determines this. The distance is equally displayed in real time. The M is displayed if the subject is still changing direction on any of the x, y, z coordinates.

The S is displayed if the subject becomes immobile.

The Functions of this indicator are enabled by the (CPU) Central processing Unit in real time. The (CPU) Compensates for environmental reflections such as iron post with intelligent mapping memory. This allows for an accurate display of information at all times by the said indicator.

Power Indicator

The Power Indicator is used to determine the batter life of the lithium ion battery powering the device. Upon reaching a ⅞ depletion of the lithium ion battery the receiving device will start to give a warning beep every 30 seconds.

Profile Indicator

The Profile Indicator is used to determine which subject when and if tracking multiple subjects has exceeded the designated radius of the tracking and receiving device. The profile of the subject, which has left the predetermined radius, is displayed by a solid black triangle. The subjects who have not exceeded the predetermined radius will be displayed by a hollow triangle. The profiles are also labeled with a M1, M2, M3 or M4 etc. This will allow discernment between the subjects being tracked.

Beep/Vibrate Indicator

The Beep/Vibrate Indicator is used to determine and display which or if both of the alarming settings are active. A bell is displayed for beeping alert. A set of quotation like or parentheses like brackets is displayed for vibrating alert.

Signal Strength Indicator

The Signal Strength Indicator is used to display the signal strength of the transmitting device in relation to the tracking and receiving device. The solid bars represent the strength of the signal being received from the transmitting device.

Altitude Indicator

The Altitude Indicator is used to display the Y coordinate of the subject being tracked in relation to that of the tracking and receiving unit. The line in the center of the Altitude level bar represents the position of the tracking and receiving device. When a subject being tracked leaves the predetermined radius and is above the tracking and receiving device the altitude indicator will display a solid bar above the line. When the subject(s) being tracked leaves the predetermined radius and is below the tracking and receiving device the altitude indicator will display a solid bar below the line.

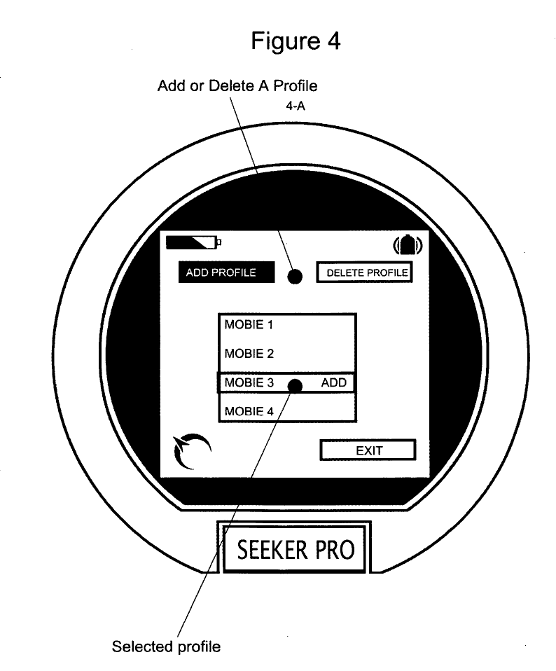

FIG. 4

Add Profile

When adding a profile, the user places the transmitter next to the watch and presses the add profile button on the tracking and receiving device. Once the button has been pressed the tracking and receiving device proceeds to learn the Pin and tracking ID of the transmitter. Once the ID and Pin have been learned the encryption prevents the pin and tracking ID from ever being used by anyone else to track the subject except the first tracking and receiving device that learned it.

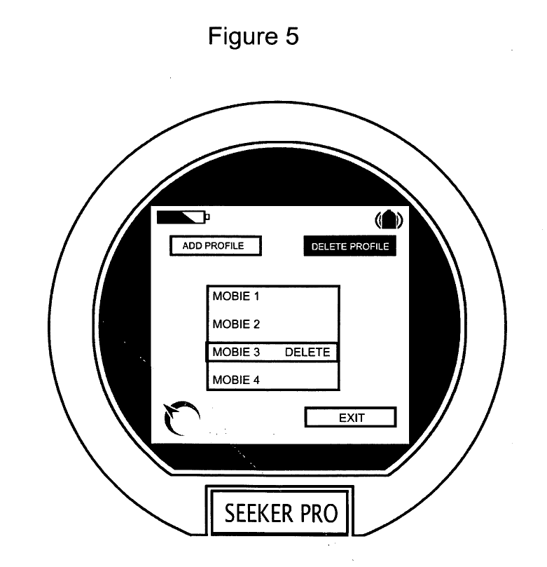

FIG. 5

Delete Profile

When adding a profile, the user scrolls down to the profile in which they wish to discard of. The user will then proceed to press the delete Profile button on the tracking and receiving device. This will permanently delete the profile from the flash memory of the tracking and receiving device's flash memory.

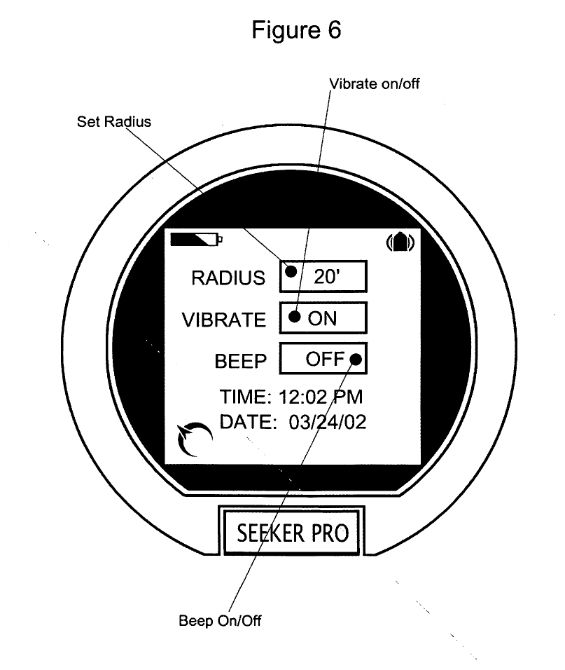

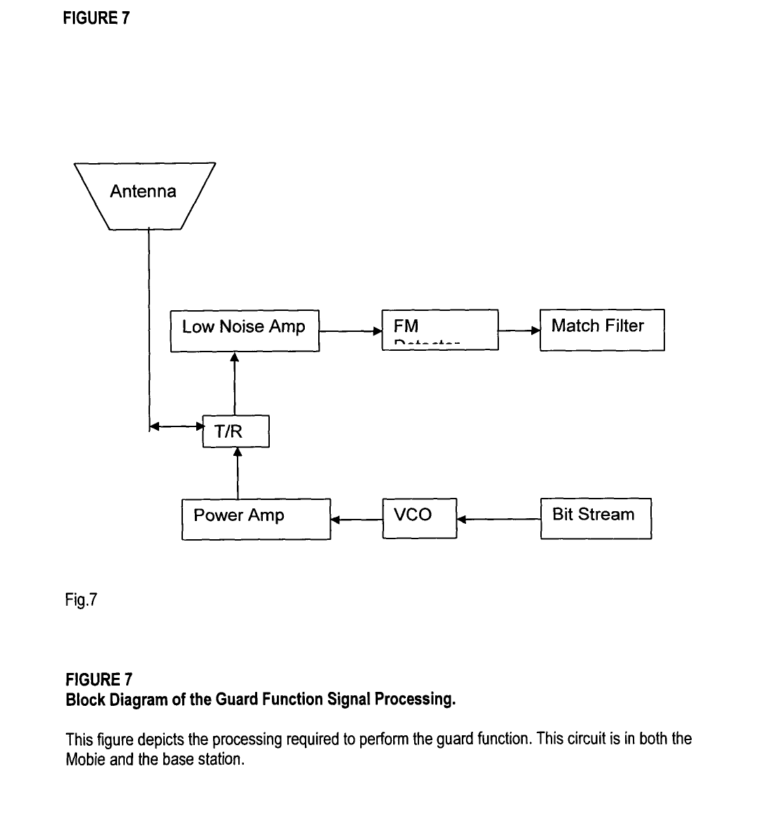

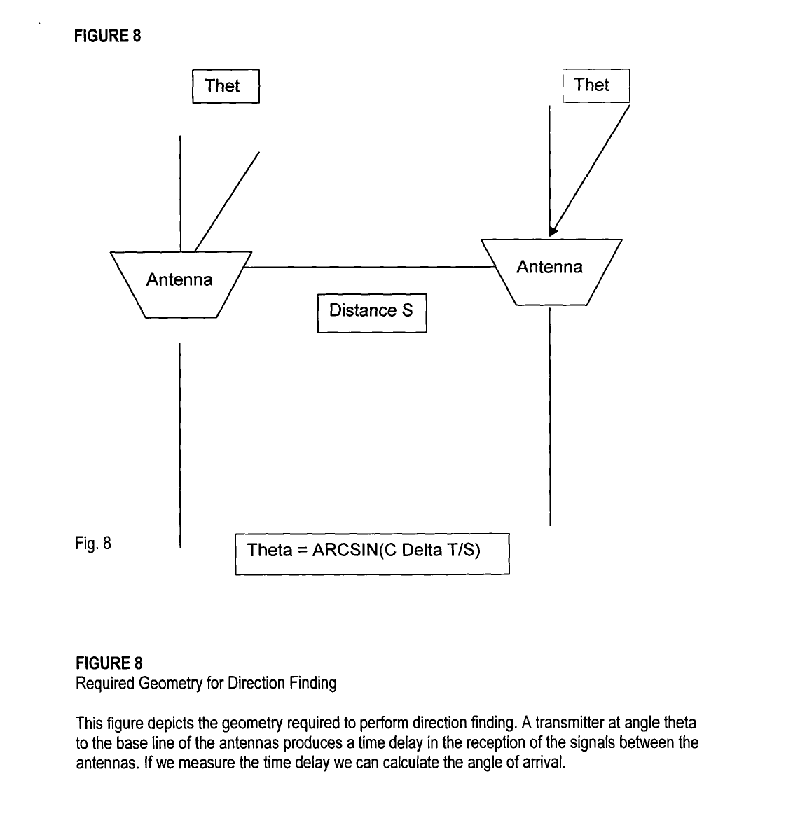

FIG. 6

GUI Programming Screen

This GUI Screen allows the user to determine and input their desired variables for tracking subjects. The first field allows you to input the radius in the number of feet that will act as a parameter or safe zone. The Next field is the vibrate field which allows you to turn the vibrate function on or off. Following that field is the beep field, which allows you to turn the beep alert function on or off.

After those 3 Critical Function Fields you have the Time and Date Fields, which allow you to set the present time and date.

### DESCRIPTION OF PREFERRED EMBODIMENT

The system and method described herein is unique in comparison to the systems and methods currently invented because of the following:

The current invention has the ability to track altitude or coordinates on the Y-axis. Integrates the ability to provide verbal direction and information in the way of locating the subject. Utilizes a Graphical User Interface for displaying information on the subject being tracked.

Utilizes unique encrypted PINS for secure monitoring. Sends signals continuously sent utilizing pulse technology and unidirectional signals, whereas other inventions use bidirectional signals. The current invention has integrated memory component to enable tracking the last coordinates sent out by the transmitting unit.

The current invention has the ability to utilize intelligent mapping for reliably tracking transmitter devices, as well may integrate the use of flash memory or cards to allow tracking using various devices as base stations.

1. A system and method for tracking and monitoring to analyze the distance, direction, altitude and specific location of a single or multiple transmitter unit(s) in relation to their location to the base utilizing a base station and transmitting device(s).

2. A wireless portable base unit for receiving signals from pre-programmed wireless portable transmitting unit(s).

3. A pre-programmed receiver that recognizes encrypted signals sent continuously from transmitter.

4. Transmitter unit that emits encrypted signals, with PIN sequencing algorithms recognized by a pre-programmed receiving unit.

5. Receiving unit utilizes Graphical User Interface (GUI) as well as audio and sensory alarms to display information on the transmitting device(s).

6. The units have an integrated memory component to enable tracking the last coordinates sent out by the transmitting unit.

7. The receiver has the capability to receive signals and exact coordinates of multiple transmitting units.

8. The CPU in the receiver unit compensates for structural interferences for improved tracking.

9. The base station is programmable to adjust perimeter distance for tracking, change notification via audible, sensory and display alarms when the transmitter device exceeds the set perimeter as well as single or multiple transmitter tracking.

10. If the transmitting device exceeds or surpasses the set radius, the base station will alarm displaying distance, direction, altitude, and specific location of a single or multiple device(s).

11. The receiving unit displays continuously the coordinates of the transmitter device(s) indicating whether the transmitter is moving or stationary, direction, distance.

12. Lithium ion batteries power the transmitter and receiver units.

13. The transmitter and receiving unit(s) are small enough to be attached to clothing, shoes, jewelry or concealed on a pet collar.

14. Each transmitter unit has a programmable PIN, which is unique for every transmitting unit.
1. The PIN is encoded and programmed into the base station; the encryption prevents the PIN from programmed more than once.
2. The base station requires confirmation of the PIN and once confirmation of the code verified, the transmitter-encrypted identification cannot be learned again for security purposes.
3. Upon activation or learning of the PIN, the transmitter continuously emits a “presence code” keeping the base station aware of its location, distance, direction, and altitude.

15. A CPU within the receiving unit, which compensates for structural interference.

16. Ability to utilize intelligent mapping for reliably tracking transmitter device(s).

17. Receiving unit has the ability to utilize programmed flash memory and or cards for tracking.

18. Receiving unit has the ability to be modified utilizing external hardware and software to enable tracking of encrypted devices.

19. Receiver picks up a preprogrammed PIN from transmitter and then automatically requests conformation for tracking.
